(19) United States
(12) Patent Application Publication
(10) Pub. No.: US 2015/0213738 A1
(43) Pub. Date: Jul. 30, 2015

(54) LABEL

(71) Applicant: HON HAI PRECISION INDUSTRY CO., LTD., New Taipei (TW)

(72) Inventors: PEI-RONG SHIEH, New Taipei (TW); CHANG-CHIN WU, New Taipei (TW)

(21) Appl. No.: 14/589,377

(22) Filed: Jan. 5, 2015

(30) Foreign Application Priority Data
Jan. 27, 2014 (TW) 103102839

(51) Int. Cl. G09F 3/10; C09J 7/02; G09F 3/02

(52) U.S. Cl. CPC G09F 3/10; G09F 3/02; C09J 7/0214; G09F 2003/0241; C09J 2201/606; C09J 2201/28; C09J 2203/334; C09J 2421/00

(57) ABSTRACT

A label includes a protective layer, an adhesive layer formed on the protective layer, and a number of bearing particles dispersed in the adhesive layer. Each resisting particle includes an elastic shell filled with adhesive. The shell defines a number of through holes. The adhesive can flow into the adhesive layer via the through holes under stress.

### FIELD

The subject matter herein generally relates to labels and in particular to labels with an adjustable adhesive strength.

### BACKGROUND

Labels are used for displaying bar codes for point-of-sales (POS) of goods such as food, as tags for delivery, or for displaying contents of containers such as bottles and cans.

### BRIEF DESCRIPTION OF THE DRAWINGS

Implementations of the present technology will now be described, by way of example only, with reference to the attached figures.

FIG. 1 is a partial, cross-sectional view of a first embodiment of a label, including a number of bearing particles.

FIG. 2 is an enlarged, cross-sectional view of the bearing particle of FIG. 1.

FIG. 3 is similar to FIG. 1, but showing the label in a state of use.

FIG. 4 is a partial, cross-sectional view of a second embodiment of a label.

FIG. 5 is similar to the FIG. 4, but showing the label in a state of use.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

A label can include a protective layer, an adhesive layer formed on the protective layer, and a number of bearing particles dispersed in the adhesive layer. Each bearing particle can include an elastic shell defining a number of through holes, and an adhesive disposed within the elastic shell. The adhesive can be configured to disperse into the adhesive layer through the through holes when the label is pressed.

A label can include a protective layer, an adhesive layer formed on the protective layer, and a number of bearing particles entirely submerged within the adhesive layer. Each bearing particle can include an elastic shell defining a number of through holes, and an adhesive disposed within the elastic shell. The adhesive can be configured to disperse into the adhesive layer through the through holes when the label is pressed.

A label can include a protective layer, an adhesive layer formed on the protective layer, and a number of bearing particles dispersed in and partially exposed from the adhesive layer. Each bearing particle can include an elastic shell defining a number of through holes, and an adhesive disposed within the elastic shell. The adhesive can be configured to disperse into the adhesive layer through the through holes when the label is pressed.

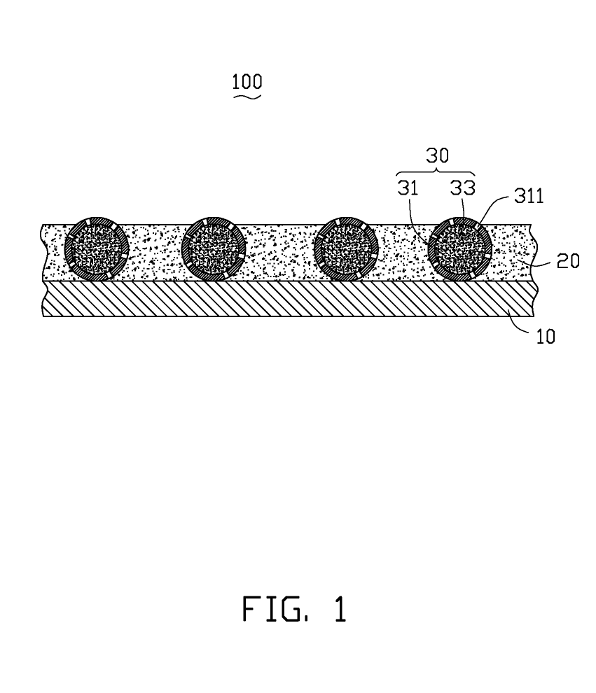

FIG. 1 illustrates an embodiment of a label 100. The label 100 can include a protective layer 10, an adhesive layer 20 formed on the protective layer 10, and a number of bearing particles 30 dispersed in the adhesive layer 20. The protective layer 10 can be made of release paper. The adhesive layer 20 can be made of resin adhesive, such as rubber adhesive, for adhering to articles (not shown). In at least one embodiment, the adhesive strength of the adhesive layer 20 can be about 0.6 kg/in.

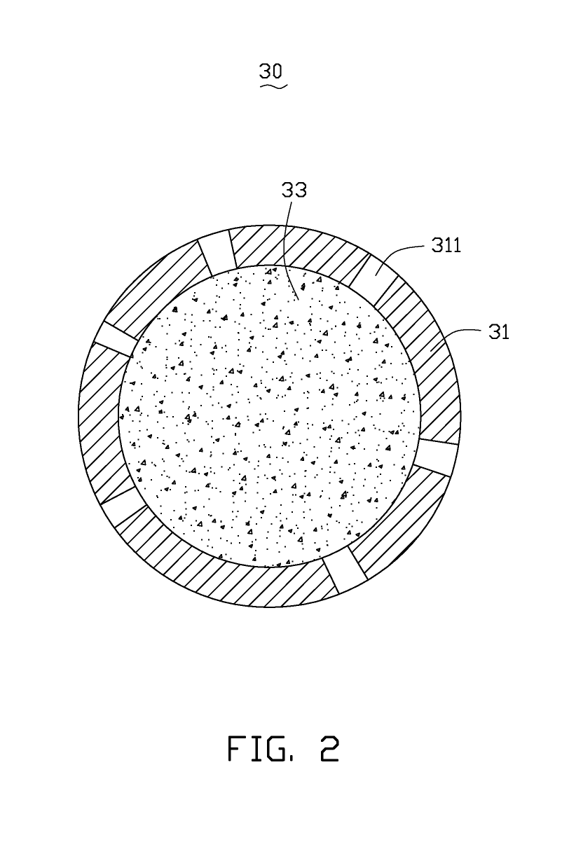

FIGS. 1 and 2 illustrate that each bearing particle 30 can include a hollow elastic shell 31, and adhesive 33 filled in the elastic shell 31. In at least one embodiment, the bearing particles 30 can be substantially spherical. In at least one embodiment, the bearing particles 30 can be arranged on a plane and uniformly dispersed in the adhesive layer 20. Each elastic shell 31 can define a number of through holes 311. The adhesive 33 can flow into the adhesive layer 20 via the through holes 311 to increase the adhesive strength of the adhesive layer 20 when the bearing particles 30 are pressed by an external force within a predetermined range. In at least one embodiment, the sum of the volume of the elastic shells 31 can be greater than about three-fifths of the volume of the adhesive layer 20. The diameter of each elastic shell 31 can be greater than the thickness of the adhesive layer 20, thus the elastic shells 31 can be exposed from the adhesive layer 20. In this way, the contact area between the adhesive layer 20 and the articles can be decreased, thus the protective layer 10 can be easily torn from the articles.

A ratio between the diameter of each elastic shell 31 and the thickness of the adhesive layer 20 can be less than three-to-two, thus the adhesive layer 20 can hold the elastic shells 31. The elastic shell 31 can be made of one or more materials selected from a group consisting of organic polymer, metal, and ceramic, for example. The organic polymer can be selected from a group consisting of vinylidene chloride acrylonitrile copolymer, poly (vinyl alcohol), poly (vinyl butyral), polymethyl methacrylate (PMMA), polyacrylonitrile, poly (vinylidene chloride), and polysulfones, for example. The metal can be stainless steel, titanium, nickel, iron, copper, or alloys thereof. The ceramic can be silicon dioxide-organic polymer hybrid material or hollow glass ceramic, for example.

In at least one embodiment, the adhesive 33 can be made of material which is the same as that of the adhesive layer 20, such as adhesive composed of rubber. In at least one embodiment, and the adhesive strength of the adhesive 33 can be greater than that of the adhesive layer 20. The adhesive strength of the adhesive 33 can be in a range from about 0.6 kg/in to about 1.2 kg/in.

In at least one embodiment, the adhesive strength of the adhesive layer 20 can be in a range from about 0.01 kg/in to about 1 kg/in. In at least one embodiment, the adhesive strength of the adhesive 33 can be less than or equal to that of the adhesive layer 20. In at least embodiment, the bearing particles 30 can be other shapes, such as triangular, hexagonal or elliptical, so long as the bearing particles 30 can be hollow and can define a number of through holes 311. In at least one embodiment, the adhesive 33 can be made of different materials than that of the adhesive layer 20. In at least one embodiment, the adhesive 30 can have the adhesive strength below 1.2 kg/in and greater than that of the adhesive layer 20.

When manufacturing the label 100, first, the elastic shells 31 can be dispersed in a first adhesive, thus the adhesive can flow into the elastic shells 31 to fill the elastic shells 31. And then, the elastic shells 31 can be dispersed in a second adhesive to form a resin. And then, the resin can be coated on the protective layer 10 to form the label 100.

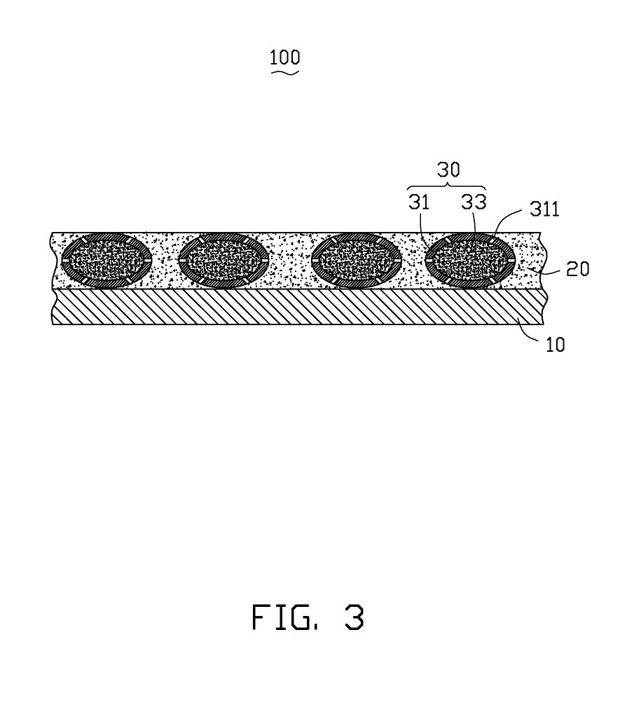

FIG. 3 illustrates when in use, the label 100 can be adhered to the articles (not shown). When the label 100 is adhered to the articles, people (not shown) cannot press the label 100, thus the elastic shells 31 cannot be pressed, and the adhesive 33 cannot flow into the adhesive layer 20 under the stress to increase an adhering strength of the label 100 to the articles. In this way, the top area of each elastic shell 31 can be in touch with the articles, and the other area of each elastic shell 31 cannot be in touch with the articles to decrease a contact area between the label 100 and the articles, and the label 100 can be easily torn from the articles. If the label 100 is not adhered to the predetermined positions of the articles, the label 100 can be torn from the articles. If the label 100 is adhered to the predetermined positions of the articles, the label 100 can be pressed. In this way, the elastic shells 31 can be deformed under the stress to change the contact area between the label 100 and the articles, and the adhesive 33 can flow into the adhesive layer 20 via the through holes 311 to increase the adhering strength of label 100 to the articles. The label 100 can be more securely adhered to the article under the stress.

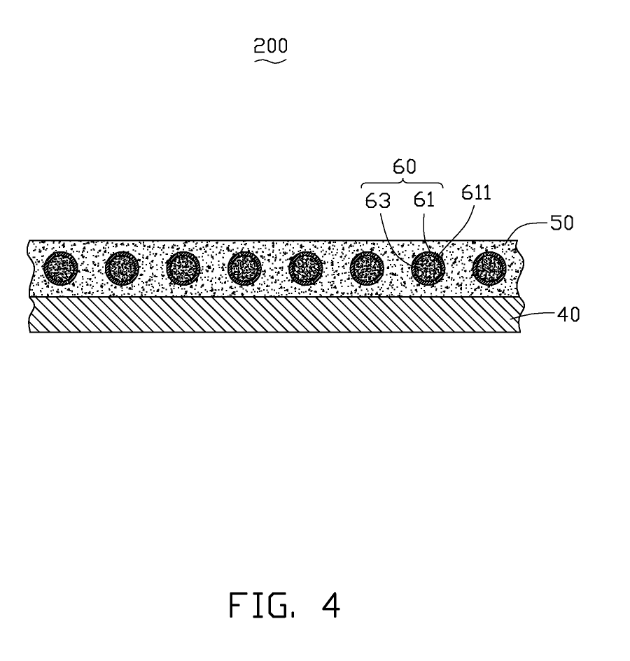

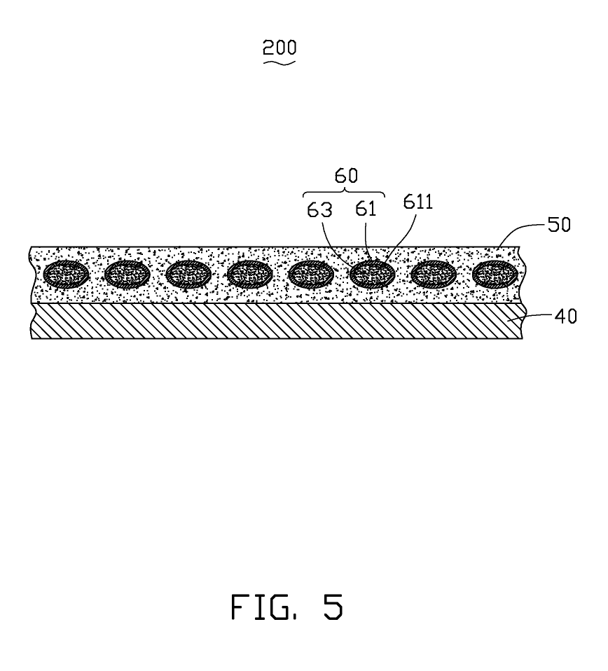

FIGS. 4 and 5 illustrate a second embodiment of a label 200. The label 200 can be similar to the label 100, and can include a protective layer 40, an adhesive layer 50 formed on the protective layer 40, and a number of bearing particles 60 dispersed in the adhesive layer 40. Each bearing particle 60 can include an elastic shell 61, and adhesive 63 filled in the elastic shell 61. In at least one embodiment, the adhesive strength of the adhesive 63 can be greater than that of the adhesive layer 50. Each elastic shell 61 can define a number of through holes 611. In at least one embodiment, the sum of the volume of the elastic shells 61 can be greater than about three-fifths of the volume of the adhesive layer 50. The diameter of each elastic shell 61 can be greater than or equal to a half of the thickness of the adhesive layer 50, and be less than the thickness of the adhesive layer 50.

FIG. 5 illustrates when in use, after the label 200 is adhered to the predetermined positions of the article, because the adhesive 63 does not flow into the adhesive layer 50, the label 200 can have a weaker adhering strength to the articles before the label 200 is pressed. After the label 200 is pressed, the adhesive 63 can flow into the adhesive layer 50 to increase the adhesive strength of the adhesive layer 50, and the label 200 can be more securely adhered to the articles.

While the present disclosure has been described with reference to particular embodiments, the description is illustrative of the disclosure and is not to be construed as limiting the disclosure. Therefore, those of ordinary skill in the art can make various modifications to the embodiments without departing from the scope of the disclosure, as defined by the appended claims.

What is claimed is:

1. A label comprising:
a protective layer;
an adhesive layer formed on the protective layer; and
a plurality of bearing particles dispersed in the adhesive layer, each bearing particle comprising:
an elastic shell defining a plurality of through holes, and
an adhesive disposed within the elastic shell,
wherein the adhesive is configured to disperse into the adhesive layer through the plurality of through holes when the label is pressed.

2. The label of claim 1, wherein the elastic shells are made of one or more materials selected from the group consisting of organic polymer, metal, and ceramic.

3. The label of claim 2, wherein the elastic shells are made of one or more materials selected from a group consisting of vinylidene chloride acrylonitrile copolymer, poly (vinyl alcohol), poly (vinyl butyral), polymethyl methacrylate (PMMA), polyacrylonitrile, poly (vinylidene chloride), and polysulfones.

4. The label of claim 2, wherein the elastic shells are made of one or more materials selected from a group consisting of stainless steel, titanium, nickel, iron, copper, and alloys.

5. The label of claim 2, wherein the elastic shells are made of one or more materials selected from a group consisting of silicon dioxide-organic polymer hybrid material and hollow glass ceramic.

6. The label of claim 1, wherein the adhesive strength of the adhesive is at least equal to that of the adhesive layer.

7. The label of claim 1, wherein both of the adhesive layer and the adhesive are made of rubber adhesive.

8. The label of claim 1, wherein a ratio between the diameter of each bearing particle and the thickness of the adhesive layer more than one-to-two, and less than three-to-two.

9. The label of claim 1, wherein the adhesive strength of the adhesive layer is about 0.6 kg/in, and the adhesive strength of the adhesive is about 1.2 kg/in.

10. The label of claim 1, wherein the sum of the volume of the elastic shells are greater than about three-fifths of the volume of the adhesive layer.

11. The label of claim 1, wherein the protective layer is made of release paper.

12. A label comprising:
a protective layer;
an adhesive layer formed on the protective layer; and
a plurality of bearing particles entirely submerged within the adhesive layer, each bearing particle comprising:
an elastic shell defining a plurality of through holes; and
an adhesive disposed within the elastic shell;
wherein the adhesive is configured to disperse into the adhesive layer through the plurality of through holes when the label is pressed.

13. A label comprising:
a protective layer;
an adhesive layer formed on the protective layer; and
a plurality of bearing particles dispersed in, and partially exposed from the adhesive layer, each bearing particle comprising:
an elastic shell defining a plurality of through holes; and
an adhesive disposed within the elastic shell;
wherein the adhesive is configured to disperse into the adhesive layer through the plurality of through holes when the label is pressed.
